(19) United States
(12) Patent Application Publication
(10) Pub. No.: US 2007/0210050 A1
(43) Pub. Date: Sep. 13, 2007

(54) Steering wheel for vehicle

(76) Inventor: Chang Soo Choi, Gyeonggi-do (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/711,394

(22) Filed: Feb. 27, 2007

(30) Foreign Application Priority Data
Feb. 27, 2006 (KR) 10-2006-0019010

(51) Int. Cl. B60L 1/02

(52) U.S. Cl. 219/204

(57) ABSTRACT

The present invention provides a steering wheel that is covered by an electric heat coating layer through simple process of applying electric heat paint on the surface of the rim. According to the invention, it is facilitated to manufacture a steering wheel having a heat-generating function, so that manufacturing cost can be saved and productivity can also be increased. Further, since the steering wheel is formed such that the rim is uniformly heated throughout the surface, a driver is provided with improved satisfaction and convenience.

### BACKGROUND OF THE INVENTION

1. Field of the Invention

The present invention relates to a steering wheel for a vehicle, particularly a steering wheel that provides a driver with improved operational convenience during winter, by applying electric heat coatings to the steering wheel for heating.

2. Description of the Related Art

In general, steering systems are designed to change the directions of rotary axes of wheels to control the travel direction of a vehicle. Such a steering system includes a steering shaft that is connected to a steering gear to rotate rotary axes of wheels and a steering wheel that is connected to an end of the steering shaft to enable a driver to control the travel direction of a vehicle into its rotary direction.

As shown in FIG. 5, a steering wheel 1 is mounted in front of the driver's seat for a driver to control the travel direction of a vehicle by rotating it to the left or right, and generally formed into a ring shape to allow the driver to easily rotate it and receive the operational force with advantage.

A driver operates the steering wheel 1 with hands holding it. However, in winter at a low temperature, because the rim is cold, it is difficult for a driver to hold the handle to operate the vehicle until the temperature inside the vehicle increases by a heater.

In order to overcome the above problems, a steering wheel with a built-in hot wire has been disclosed in Korean Patent Publication No. 1999-025947, titled “steering wheel with built-in hot wire.”

As shown in FIG. 6, a steering wheel 1 has a built-in hot wire 1a throughout the entire length and a power switch for applying power to the hot wire 1a. When the power switch is turned on, a current flows through the hot wire 1a and heat is generated at a predetermined temperature. The heat transfers to the outside of the steering wheel 1 and warms the driver's hands.

Other than the above, though not shown, another steering wheel has been disclosed in Korean Patent Publication No. 2003-0066573, titled “Steering Wheel and Method of Manufacturing thereof.” According to the above-mentioned steering wheel, the rim is plated with a heat conductor on the surface in a predetermined pattern and generates heat by supplying power.

However, when a hot wire is directly provided inside a steering wheel, because the hot wire should be disposed inside the rim of the steering wheel during the manufacturing process of the rim, the manufacturing was difficult. Further, after the manufacturing, the rim decreased in strength due to the difference in quality between the hot wire and the plastic resin of the rim.

Furthermore, because it takes long for the heat generated from the hot wire to transfer to the rim's surface, only feeble heat reached the driver's hands. In addition, the rim is partially hot where the hot wire passes through, while the other part around the hot wire is not warm enough, so that a driver was dissatisfied with it.

As for a steering wheel with a rim plated with a heat conductor on the surface in a predetermined pattern, adhesive first coat paint should be applied respectively between the heat conductor and the surface of the rim, and the heat conductor and a transfer paper. Further, the plating is applied by depositing the heat conductor with the use of plasma under vacuum atmosphere. Therefore, the manufacturing process was difficult and complicated, which resulted in poor productivity with a high manufacturing cost.

### SUMMARY OF THE INVENTION

Accordingly, an object of the present invention is to provide a steering wheel for a vehicle of which manufacturing process is simple by applying electric heat paint on the surface of the rim and generating heat and that more satisfy a driver by uniformly generating heat throughout the entire rim after manufactured.

A steering wheel for a vehicle according to an embodiment of the present invention includes a rim, a body bracket mounted at the end of a steering shaft, spokes connecting the body bracket with the rim, an electric heat coating layer formed by applying electric heat paint on the surface of the rim, a plurality of power lines disposed on the surface of the rim to supply power to the electric heat coating layer, an insulating means formed on the electric heat coating layer, and a controller supplying power to the power lines.

### BRIEF DESCRIPTION OF THE DRAWINGS

The above and other features and advantages of the present invention will become more apparent by describing, in detail, preferred embodiments thereof with reference to the attached drawings in which:

FIG. 1 is a front view of a steering wheel according to an embodiment of the invention;

FIG. 2 is a plan cross-sectional view of FIG. 1;

FIG. 3 is a transverse cross-sectional view of the rim shown in FIG. 1 before a decorative layer and a coating layer are formed;

FIG. 4 is a view showing the rim with decorative and coating layers formed;

FIG. 5 is a perspective view of main parts of a common steering wheel mounted in a vehicle in the related art; and

FIG. 6 is a cross-sectional view of a steering wheel with a built-in heat wire in the related art.

### DESCRIPTION OF THE PREFERRED EMBODIMENTS

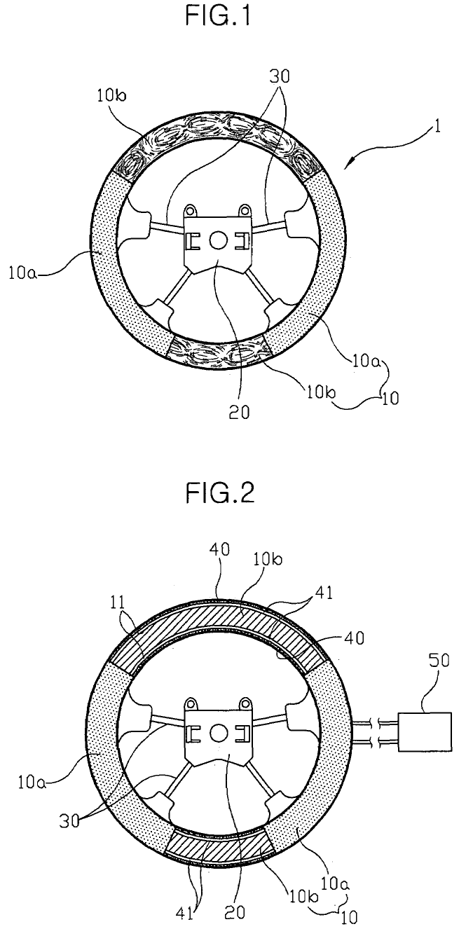

As shown in FIG. 1, a steering wheel 1 according to an embodiment of the invention has a body bracket 20 mounted inside a ring-shaped rim 10 to place a horn or an air bag and the body bracket 20 is connected to the rim 10 by spokes 30.

Usually formed into a T-shaped linkage, the spoke 30 may connect the body bracket 20 with the rim 10 by inserting the body into the rim 10 and then welding the end to the body bracket 20. Alternatively, the spoke 30 may integrally extend from the body bracket 20 and connect the body bracket 20 with the rim 10 by inserting the end into the rim 10. These have been known in the related art.

The rim 10 may be formed into a ring-shaped single piece or consists of first rim members 10a that are formed by injection molding and connected with the spokes 30 and second rim members 10b that are made of foaming urethane or non-foaming urethane and connect the first rim members 10a.

For example, when the rim 10 is composed of the first rims 10a and second rims 10b, the first rims 10a may be covered with synthetic leather, leather, or synthetic resin on the surface and the second rim members 10b may be provided with a decorative layer 60 that will be described below.

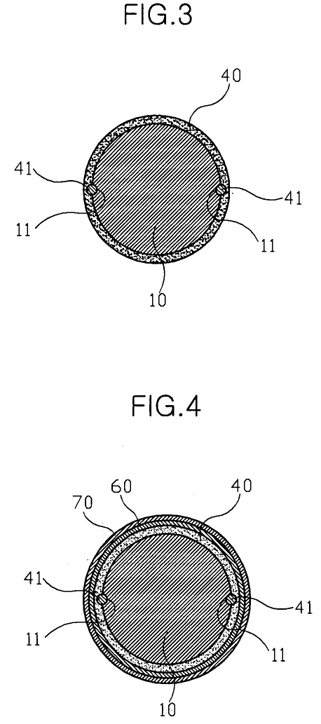

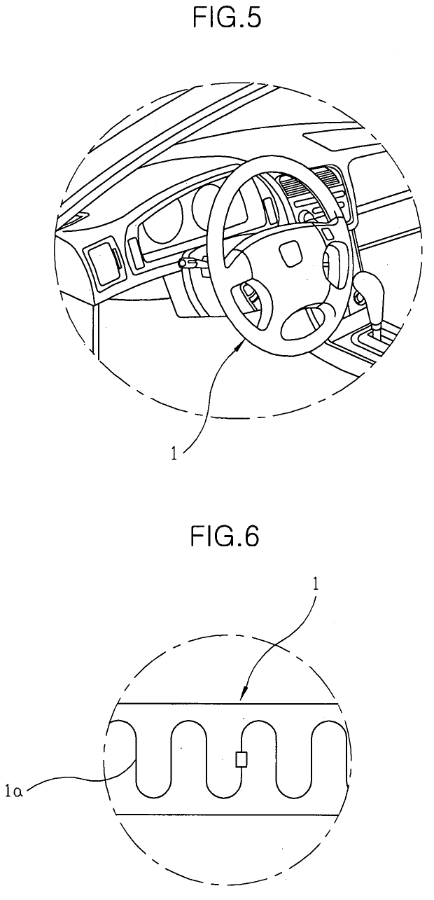

As shown in FIGS. 2 and 3, a power line insertion groove 11 is respectively formed along the inner and outer peripheries of the rim 10 so as to have a depth such that a part of a power line 41 is inserted in the groove 11 and the other is exposed outside.

Making a pair, the power lines 41 face each other through the rim 10 and disposed along the peripheries of the rim 10. On the other hand, in the present embodiment of the invention, the power line 41 is respectively disposed along the inner and outer peripheries of the rim 10 by way of an example.

The power lines 41 are inserted into the power line insertion grooves 11 on the outside and inside of the rim 10, respectively, before the electric heat coating layer 40 is applied, with a portion of the power line 41 protruding from the surfaces of the rim 10. The protruding portions from the surfaces of the rim 10 are connected with the electric heat coating layer 40 to allow a current to flow.

Alternatively, a plurality of pairs of power line insertion grooves 11 may be formed along the peripheries of the rim 10 with constant interval and the power lines 41 may also be formed into a plurality of pairs. According to this configuration, a current flowing through the power lines 41 generates more uniform heat throughout the electric heat coating layer 40.

The electric heat coating layer 40 is formed on the surface of the rim 10 by applying electric heat paint and preferably has a thickness in the range of 40 to 50 μm in thickness. However, the thickness is easily changeable by a designer in consideration of the voltage level or current value supplied through the electric heat coating layer 40 or the temperature of heat generated from the electric heat coating layer 40.

For example, electric heat paint for the electric heat coating layer 40 may be a mixture of general paint solution and a conductive main substance that generates heat with large electrical resistance when a current flows due to large resistance, such as carbon powder. A variety of additive substances known in the art may be mixed with the mixture to improve adhesive strength, physical properties, such as heatproof, machinability, heat preservation, and electrical properties for appropriately adjusting conductivity of the paint.

For example, methylethylketone may be used as additive substances to improve physical properties, and BaTi203, Zn, Ag, Cu, Al, or the like may be used as additive substances to improve electrical properties.

Accordingly, when the power line 41 is supplied with power, a current flows into the electric heat coating layer 40 and heat is generated by electrical resistance, so that a driver holding the rim 10 for operation feels the warmth.

When the electric heat coating layer 40 increases in temperature at a predetermined level, the increase is stopped and the temperature is maintained at the level that allows a driver to feel warm with hands by a controller 50. Therefore, it is not overheated up to a level such that a driver has difficulty in holding it or suffers a burn on the hands.

On the other hand, the power lines 41 are connected to the controller 50 that controls power supply and the controller 50 has a power switch that is turned on/off by a driver.

The controller 50 further includes a temperature control switch to control the heat temperature of the electric heat coating layer 40 by controlling the voltage level and current value. The temperature control switch, which controls the electric heat by varying the voltage or current, has been widely known in the art and is not described in detail herein.

When a driver operates the switch of the controller to turn on, power is supplied from the controller 50 to the power line 41 and a current flows into the electric heat coating layer 40 by the supplied power, and subsequently, heat is generated in the electric heat coating layer 40 by electric resistance.

Since two power lines 41 that allow a current to flow into the electric heat coating layer 40 are disposed along the inside and outside peripheries of the rim 10, power is uniformly supplied throughout the entire electric heat coating layer 40 and electric heat can be uniformly and simultaneously generated throughout the entire electric heat coating layer.

Further, a driver can freely control the temperature of the electric heat coating layer 40 to a desired temperature by operating the temperature control switch of the controller 50.

On the other hand, an insulating means that insulates the body of a driver against the electric heat coating layer 40 is provided on the surface of the rim 10, because the driver may receive an electric shock when holding the electric heat coating layer 40 with driver's hands.

The insulating means is composed of a decorative layer 60 and coating layer 70 that are provided on the surface of the electric heat coating layer 40. The decorative layer 60 may be formed by applying paint having good heat resistance and insulation property on the surface of the electric heat coating layer 40 or transferring a transfer film of insulating material onto the surface of the electric heat coating layer 40 with Hydraulic Transfer Method. For reference, the above-mentioned insulating paint and transfer film of insulating material have been known in the art and are not described in detail herein.

The Hydraulic Transfer Method gives elegance to the appearance by printing a pattern of wood, metal, carbon, marble, or hair line.

An example of the decoration layer 60 formed by Hydraulic Transfer Method is described below.

In order to activate a transfer film with a pattern printed on a side of a water-soluble raw film by an adhesive ink, the transfer film is drawn out from a film roll and heated by a heat roll. Thereafter, an activator is applied onto the printed side and the transfer film is moved onto the surface of water in a transfer bath.

The transfer film is continuously swollen while moving and sufficiently activated by the activator K, so that the transferred pattern reaches a state just short of destroying.

With the pattern being just short of destroying, the steering wheel 1 is conveyed to a steering wheel conveying device and then immersed down into the water at a predetermined angle, pushing down the transfer film. While they are in the water, the ink is printed onto the surface of the injection-molded parts of the steering wheel 1, that is, the surface of the rim 10 by the stress created in the water.

The steering wheel 1 is immersed into the water with the transfer film on the water, with being fixed to the conveying device such that the front, which faces a driver when mounted in a vehicle, faces down, that is, faces the water. After Hydraulic Transfer Method, a joint is formed at the opposite side to the side that has first become in contact with the transfer film of the rim 10 of the steering wheel 1. The joint may be formed at other position by varying the immersion angle of the steering wheel 1.

The coating layer 70 is made of a transparent material having an insulating property and showing the pattern on the decorative layer 60. The transparent material may be, for example, fluororesin, urethane, acrylic resin, transparent synthetic resin, or a coating film containing organosilicon compounds and titanium oxide particles.

As described above, since the electric heat coating layer 40 is covered by the decorative layer 60 that has an insulating property and shows a variety of colors and patterns, the steering wheel 1 is provided with decorative beauty in the appearance and the decorative layer 60 insulates the body of a driver from the electric heat coating layer 40. Further, since the coating layer 70 additionally covers the decorative layer 60, it improves not only the insulating property, but also durability by preventing damage to the decorative layer 60, such as scratches.

The insulating means according to the embodiment of the invention may be, other than the decorative layer 60 and coating layer 70, synthetic leather, leather, or a cover of synthetic resin to cover the rim 10.

The present invention, as described above, is to form an electric heat coating layer that generates heat when power is supplied, by a simple process of applying electric heat paint on the surface of the rim. Accordingly, it is facilitated to manufacture a steering wheel having a heat-generating function, so that manufacturing cost can be saved and productivity can also be increased.

Further, since the steering wheel is formed such that the rim is uniformly heated throughout the entire surface, a driver is provided with improved satisfaction and convenience.

Although the preferred embodiments of the present invention have been disclosed for illustrative purposes, those skilled in the art will appreciate that various modifications, additions and substitutions are possible, without departing from the scope and spirit of the invention as disclosed in the appended claims.

What is claimed is:

1. A steering wheel for a vehicle, comprising:
a rim;
a body bracket mounted at the end of a steering shaft;
spokes connecting the body bracket with the rim;
an electric heat coating layer formed by applying electric heat paint on the surface of the rim;
a plurality of power lines disposed on the surface of the rim to supply power to the electric heat coating layer;
an insulating means formed on the surface of the electric heat coating layer; and
a controller supplying power to the power lines.

2. The steering wheel as set forth in claim 1, wherein the power lines are disposed along the periphery of the rim.

3. The steering wheel as set forth in claim 1, wherein the insulating means is made of an insulating material and includes a decorative layer formed on the surface of the rim and a coating layer formed on the surface of the decorative layer.

4. The steering wheel as set forth in claim 3, wherein the decorative layer is formed by transferring a transfer film made of an insulating material onto the surface of the electric heat coating layer using Hydraulic Transfer Method.

5. The steering wheel as set forth in claim 3, wherein the decorative layer is formed by applying insulating paint onto the surface of the electric heat coating layer.

6. The steering wheel as set forth in claim 1, wherein the power lines are partially inserted in power line insertion grooves that are formed along the periphery of the rim.
